(19) United States
(12) Patent Application Publication
(10) Pub. No.: US 2024/0144246 A1
(43) Pub. Date: May 2, 2024

(54) SYSTEM AND METHOD FOR PROOF-OF-STAKE VALIDATED SERVING OF STAKE-PRIORITIZED UTILITY

(71) Applicant: Opentensor Foundation, Toronto (CA)

(72) Inventors: Jacob Robert Steeves, Comox (CA); Ala Shaabana, Toronto (CA); Francois Pierre Sarel Luus, Pretoria (ZA); Sin Tai Liu, Toronto (CA); Yuiqan Hu, Coquitlam (CA)

(73) Assignee: Opentensor Foundation, Toronto, ON (CA)

(21) Appl. No.: 17/979,621

(22) Filed: Nov. 2, 2022

(51) Int. Cl. G06Q 20/36; H04L 9/32

(52) U.S. Cl. CPC G06Q 20/3674; H04L 9/3263

(57) ABSTRACT

Provided is a system and method for stake-prioritized serving of utility in a network of a plurality of servers, with stake verification on a proof-of-stake blockchain. For stake-controlled inflation the utility may be validated in a plurality of validators that set stake-weighted utility assessment values for each utility server registered on the blockchain, where a consensus calculator may determine a relative utility measure and level of agreement and adjusts the next block reward so that servers obtain inflation in proportion to their level of agreed utility. New servers and validators may register and may thereby activate stake in the utility network by solving a proof-of-work challenge verified on the blockchain, after which servers can serve utility and validators can validate utility and influence blockchain inflation distribution.

### FIELD OF THE INVENTION

The present disclosure relates, generally, to systems and methods for networks adapted to aid and supplement transactions based on blockchain. However, more specifically, the present disclosure relates to systems and methods for prioritized access to a utility network based on a proof-of-stake blockchain.

### INTRODUCTION

Conventionally, service provision in networked environments (e.g., the internet) is defined as delivery of specific requests of informational utility in the form of various data modalities such as text, images, audio, and/or video content. Service delivery primarily involves data storage, networking, and computational resources executing various software capabilities that produce the required utility. Informational utility, such as the creative generation of text, images, or video from short prompt requests, is typically of subjective value to the requesting client. Thus, the client's assessment of the utility should influence the pricing of the utility, such that market equilibrium is reached.

Additionally, objective assessment is also possible with information-theoretic measures using large representative datasets as objective guides for generative probability distributions. Although, clients may own proprietary datasets and objective functions not shared with the entire client base, hence the need for each client to individually evaluate utility received. Consequently, a client and service provider would not be able to negotiate directly on the value of the utility, since the client cannot (or would not) share the information necessary for other parties to verify its measurement of the utility.

Centralized service providers typically determine a fixed pricing across a range of services. Such pricing may be arbitrary or suboptimal considering the client purchasing power and specific service needs. Centralized price determination can fail in the case of complex client-subjective utility where the requested utility is often unique and may depend on a combination of responses from a plurality of servers. Instead, decentralized utility networks can potentially reach consensus on the relative pricing of servers in its network, collectively weighing individualized evaluations from all participants in its client base. However, bad actors can attempt to subvert this consensus by voting for a relatively high pricing on their own servers, thereby potentially obtaining higher rewards than deserved. It would be desirable to facilitate decentralized consensus for incentivizing accurate relative pricing, while penalizing low-consensus price voting which may be indicative of subversion.

Further, it would be desirable to provide stake-weighted mean consensus on peer values, factoring in uncertainty of the consensus, which may be required to penalize relatively high disagreement in inflation distribution and combat subversion by bad actors.

Additionally, decentralized consensus can be prone to Sybil attacks, where bad actors may register a large number of participant nodes in a limited-slot utility network, and as a result may gain a disproportionately large influence on the pricing consensus. It would be desirable to facilitate registration of one of the limited participation slots in the utility network to mitigate unchecked growth of potential bad actors.

A blockchain can host the consensus algorithm and distribute new inflation based on the relative pricing consensus, where utility servers receive a proportion of fixed block reward equal to their relative utility price. Closing the value cycle may require that clients buy these tokens from servers to compensate for their service delivery costs. However, the exact service delivery costs depend on external factors related to resource costing and software creation labor cost, which may be variable over time and hard to estimate by clients. Hence, a relative pricing can be more readily estimated by clients based on their subjective and objective evaluation of utility, but the absolute pricing (with resource-cost awareness) can then still be resolved in external markets facilitated by fiat currency or stable coins as intermediaries in exchange for the blockchain token that servers receive as reward.

Compensation of servers is important to sustain market equilibrium, where value production is properly offset with relatively accurate reward. Servers have limited service capacity and need to direct their resources to clients according to their propensity to buy token rewards that directly or indirectly compensate service. Service prioritization may need to reflect this relative propensity of a client, which could be enforced as requiring clients to post stake on a proof-of-stake blockchain, where a higher stake gains a higher service priority in turn. This may close the value cycle by requiring clients to buy token rewards, which originate from servers, thus ensuring compensation for service.

Traditionally, prioritization in a permissioned blockchain may require peer endorsement and ordering nodes to establish priority. However, in a decentralized permissionless blockchain, the blockchain itself should be used to verify stake or the propensity to compensate for service.

Some alleged solutions may require queuing requests comprising information that identifies a quantity of tokens and said tokens may need to be sold directly for priority access. However, it would be desirable instead that the client stake should be verified directly on the blockchain, and the onerous demand of absolute price estimation should be shifted from the client to external markets by avoiding direct sale for priority access. Thus, it would be further desirable if the system could rely purely on relative pricing by requiring clients to stake instead for priority, where compensation to servers is indirect through external markets that can handle the variability of absolute pricing.

### SUMMARY

The invention of the present disclosure may be a computer-implemented method comprising requesting, via a requesting peer, a list of registered nodes from a blockchain node; formulating, via the requesting peer, a request message; transmitting, from the requesting peer to one or more selected servers, the request message; and inputting, via a server response processor for each of the one or more selected servers, the request message. The computer-implemented method may further comprise selecting, via the server response processor for each of the one or more selected servers, a machine learning model appropriate for a request type, wherein the request message comprises the request type; receiving, via the requesting peer, a response from each of the one or more selected servers; and matching, via the requesting peer, the response to the request message. In yet a further embodiment, the computer-implemented method may comprise performing, via the requesting peer, a utility measure; and updating a weight storage with a weight entry for each of the one or more selected servers.

In another embodiment, the computer-implemented method may comprise selecting the one or more selected servers from the list of registered nodes according to one or more criteria, the one or more criteria comprising at least the request type. In an embodiment, the step of formulating, via the requesting peer, the request message may include formulated said request message based on reference data. The request message may be configured to withhold a portion of the reference data from the one or more selected servers.

In an embodiment, each of the one or more selected servers comprises a request listener, a response cost estimator, and a stake verifier, wherein the request listener is configured to receive the request message, wherein the response cost estimator is configured to generate a cost estimate based on the request message, and wherein the stake verifier is configured to connect with the blockchain node and request a blockchain-verified stake of the requesting peer. The weight entry for each of the one or more selected servers may be a moving average over a window of weight update events.

In a further embodiment the computer-implemented method may, furthering comprise submitting one or more hot wallet signed weights to the blockchain node; and recording the one or more hot wallet signed weights in a blockchain ledger and a state. In yet a further embodiment, the computer-implemented method may comprise generating, via a candidate peer node comprising a cold wallet and a hot wallet, a cold blockchain wallet private-public keypair designated as the cold wallet; generating, via the candidate peer node, a hot blockchain wallet private-public keypair designated as the hot wallet, wherein the hot wallet is linked to the cold wallet, wherein the cold blockchain wallet private-public keypair comprises a cold public key and a cold private key, and wherein the hot blockchain wallet private-public keypair comprises a hot public key and a hot private key. In such an embodiment, the method may further comprise signing, via the candidate peer node, a registration request with at least one of the cold private key and the hot private key, wherein the registration request comprises at least one of the cold public key and the hot public key; transmitting the signed registration request to the blockchain node; and verifying, via a registration listener and the at least one of the cold public key and the hot public key, an authentic status or inauthentic status of the signed registration request. In yet a further embodiment, the computer-implemented method may comprise retrieving, if the signed registration request is of the authentic status, via the blockchain node, from a challenge storage a challenge message; transmitting the challenge message to the candidate peer node; and inputting the challenge message to a challenge solver, wherein the challenge solver is configured to compute a solution corresponding to the challenge message.

The challenge message may be a proof-of-work challenge, wherein the proof-of-work challenge may comprise a generated secret seed known only to the blockchain node. The challenge message may comprise a challenge difficulty, wherein the challenge difficulty may be modified the blockchain node. The step of updating the weight storage may further comprise comparative evaluation adapted to allow the requesting peer to assign a comparative weight to each of the one or more servers, wherein all comparative weights sum to one. However, in various embodiments the challenge message may include any suitable challenge. Yet further, the method may include a variety of challenges of any suitable challenge type or content.

In an embodiment, the computer-implemented method may further comprise executing a consensus algorithm configured to distribute inflation via block rewards according to each of the comparative weights for each of the one or more servers. The computer-implemented method may further comprise calculating, via a bond calculator in the blockchain node, a bond for the requesting peer, wherein the bond correlates to a share of an incentive distribution of each of the one or more selected servers. Yet further, the computer-implemented method may comprise calculating and storing, via a rank calculator in the blockchain node, a server rank for each of the one or more selected servers, wherein the rank may be a function of a stake storage and the weight storage, wherein the rank may be calculated as the sum over registered peers of the product of an active stake of said registered peer and the weight assigned by said registered peer to a particular server of the one or more selected servers.

The computer-implemented method may further comprise calculating and storing, via a trust calculator in the blockchain node, a trust value comprising one or more trust factors, the one or more trust factors functions of a stake storage, a bond storage, a rank storage, and the weight storage, and wherein a first trust component is based on a bond-weighted consensus and uncertainty of consensus.

The trust calculator may be configured to factor a second trust component as a function over the stake storage and the weight storage on the blockchain, wherein the final trust may be calculated from at least the first trust component and the second trust component, wherein the second trust component may sum the stake of the registered peers with a non-zero weight pointing to one of the one or more selected servers, and wherein a full trust may be activated when a majority stake trusts that the one of the one or more selected servers is producing non-zero utility. In an embodiment, the computer-implemented method may further comprise calculating an incentive distribution, via an incentive calculator, the incentive calculator configured to combine the rank and the trust to calculate the incentive distribution for each of the one or more selected servers. Yet further, such a method may comprise calculating and updating, via an incentive distributor, the stake of each of the registered peers based on at least said calculated incentive distribution. The method may also comprise maintaining, for each of the one or more servers, a priority queue comprising a response cost estimator and a sampling device, wherein the sampling device comprises a probability storage for the request message, wherein a probability value for responding to the request message is calculated as a function of blockchain stake, bonds, and the request types.

These and other aspects, features, and advantages of the present invention will become more readily apparent from the following drawings and the detailed description of the preferred embodiments.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 is an illustrative block diagram of a system based on a computer.

FIG. 2 is an illustration of a computing machine.

FIG. 3 is an illustration of an embodiment of a blockchain network and a utility network and possible interactions thereof.

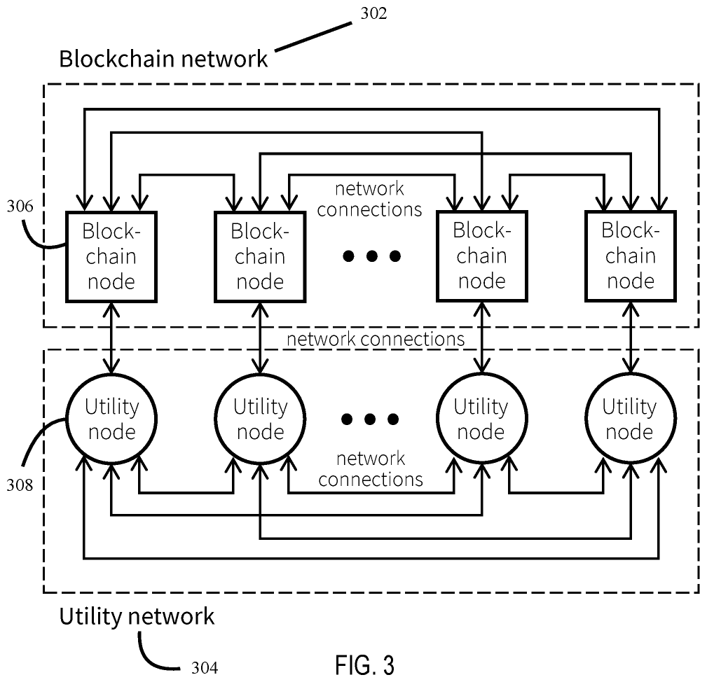

FIG. 4 is an illustration depicting an embodiment of a registration process for candidate peers on the utility network, facilitated by a blockchain node.

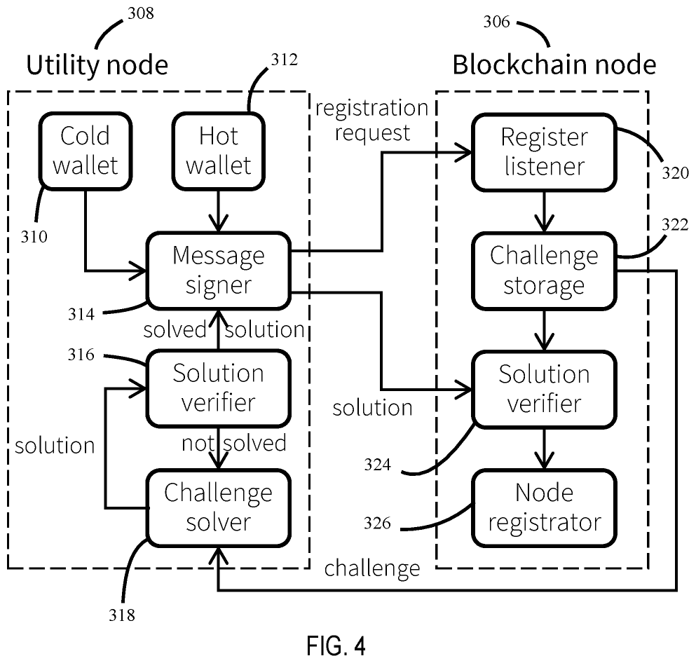

FIG. 5 is an illustration depicting an embodiment of an incentive distribution calculation process on the blockchain, using relative utility measures of servers as weights from participating nodes in the utility network.

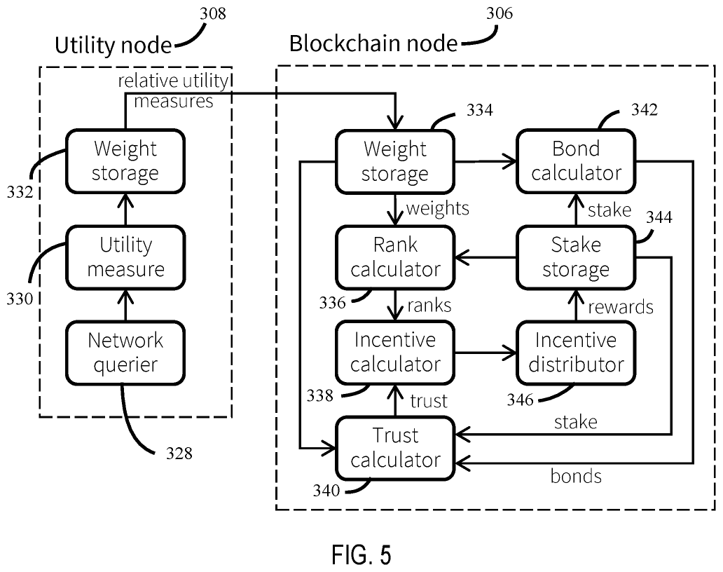

FIG. 6 is an illustration of an embodiment of a client and server request prioritization process in the utility network.

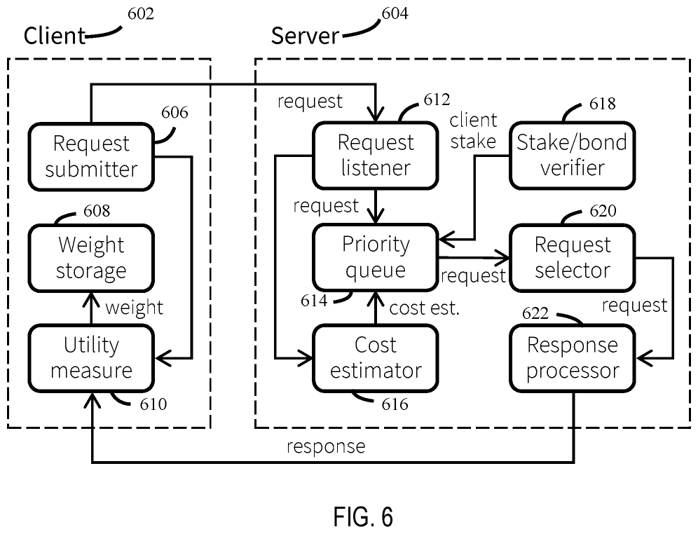

FIG. 7 is an illustration of an exemplary process of querying on the utility network, followed by blockchain incentive distribution.

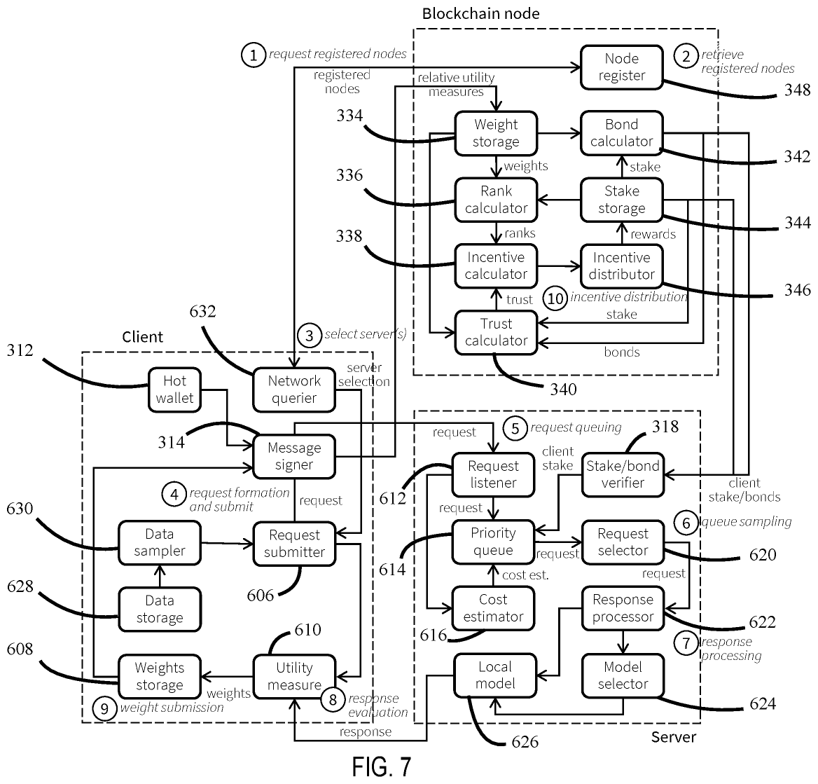

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

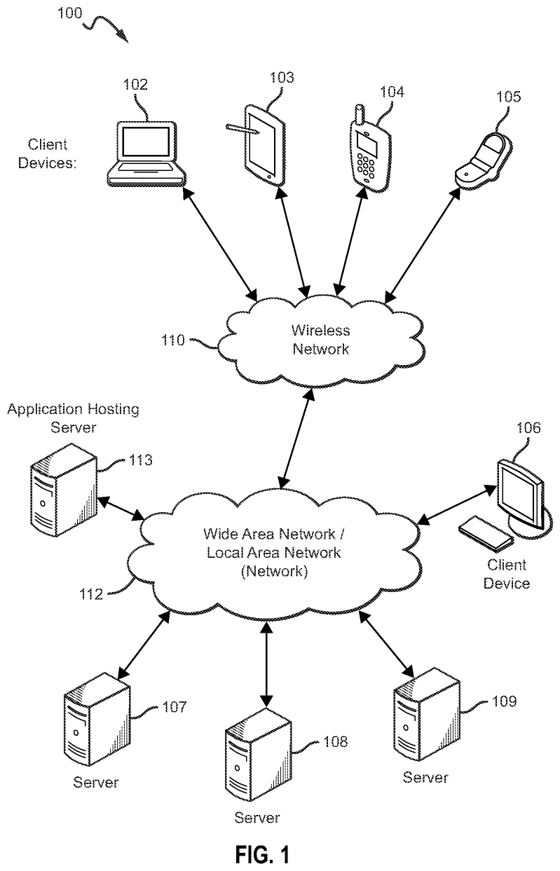

FIG. 1 illustrates components of one embodiment of an environment in which the invention may be practiced. Not all of the components may be required to practice the invention, and variations in the arrangement and type of the components may be made without departing from the spirit or scope of the invention. As shown, the system 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. Various of the client devices 102-106 may include, for example, desktop computers, laptop computers, set top boxes, tablets, cell phones, smart phones, smart speakers, wearable devices (such as the Apple Watch) and the like. Servers 107-109 can include, for example, one or more application servers, content servers, search servers, and the like. FIG. 1 also illustrates application hosting server 113.

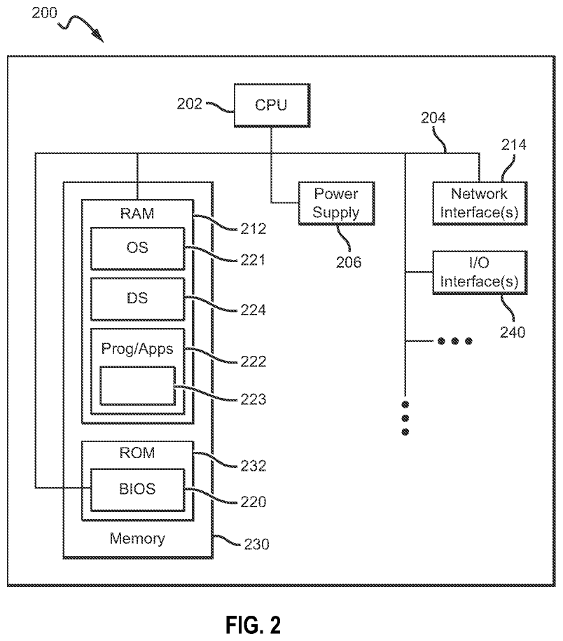

FIG. 2 illustrates a block diagram of an electronic device 200 that can implement one or more aspects of an apparatus, system and method for increasing mobile application user engagement (the “Engine”) according to one embodiment of the invention. Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software and other tools necessary to implement or facilitate methods and systems according to embodiments of the invention. The elements may exist on a single computer or be distributed among multiple computers, servers, devices or entities.

The power supply 206 contains one or more power components, and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server may, for example, host a web site that can provide a user interface for administration of example aspects of the Engine.

Any computing device capable of sending, receiving, and processing data over a wired and/or a wireless network may act as a server, such as in facilitating aspects of implementations of the Engine. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system and method of the Engine. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the Engine. Content may include, for example, text, images, audio, video, and the like.

In example aspects of the apparatus, system and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system and method embodying the Engine, may range widely in terms of capabilities and features. For example, a cell phone, smart phone or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices 102-106, for example, as may be used in an example apparatus, system and method implementing the Engine, may run a variety of operating systems, including personal computer operating systems such as Windows, iOS or Linux, and mobile operating systems such as iOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, system and method implementing the Engine, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system and method implementing the Engine, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, and the like. Access technologies such as 2G, 2.5G, 3G, 4G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the Engine, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present invention include apparatuses, systems, and methods implementing the Engine. Embodiments of the present invention may be implemented on one or more of client devices 102-106, which are communicatively coupled to servers including servers 107-109. Moreover, client devices 102-106 may be communicatively (wirelessly or wired) coupled to one another. In particular, software aspects of the Engine may be implemented in the program 223. The program 223 may be implemented on one or more client devices 102-106, one or more servers 107-109, and 113, or a combination of one or more client devices 102-106, and one or more servers 107-109 and 113.

As noted above, embodiments of the present invention relate to apparatuses, methods, and systems prioritizing access to a utility network based on a proof-of-stake blockchain with a consensus component for stake-controlled inflation distribution to nodes in the network according to relative measurements of utility served in the network. However, more generally, the invention of the present disclosure may include implementation of any networking technique, blockchain aspect, decentralized communications, algorithms, or processes described herein. For the purposes of this disclosure, the methods and/or systems disclosed herein may be referred to as “the method” or “the system.”

In an embodiment, the system provides a consensus on relative utility measures according to the collective client base. Such utility measures may involve complex subjective utility types like the informational utility of the creative generation of text, images, or video from short prompt requests, where direct negotiation on the utility value cannot be conducted between a client and server due to the subjective or proprietary nature of the client operation.

In an embodiment, the blockchain is configured to distribute a certain ratio of new token inflation as incentive to servers proportional to their relative utility according to the consensus, and further distribute the remainder of fixed new inflation as rewards to clients and stakeholders according to the accuracy of their utility measurements compared to the consensus. Thus, in effect, the latter reward distribution may be utilized for stakeholders purchasing a bond from a server in exchange for a proportion of their stake allocated to the stakeholder's measurement of that server's utility. Accordingly, such stakeholders may then receive rewards as a certain fixed ratio of the eventual incentive received by this server via the consensus distribution.

Servers may be configured to prioritize requests proportional to the amount of stake a client has on the proof-of-stake blockchain (i.e., where a larger stake receives higher service priority). In ordinary operation, external markets allow servers to sell their token reward to clients for fiat currency or stable coin at an absolute price per unit of utility as determined through ordinary market dynamics by the collective network participants. Such an operation may close the value cycle by compensating servers and growing client stake for ensuring service capacity on the network.

In an embodiment, the blockchain appends new data blocks at an approximately fixed frequency, wherein the data blocks comprise peer utility measurements of servers in the peer-to-peer network. The blocks and the blockchain size may be dependent on the size of the network, which may be constrained to ensure operational viability under storage, computational, and networking limitations. Therefore, the system may ensure that limited slots in the peer-to-peer network are occupied by participants with competitively high computational resources indicative of the capacity to compute informational utility. Thus, the system may require proof-of-work as a readily verifiable requirement for registering a slot in the network before participating in service delivery or activating client stake for influencing the consensus on server evaluation.

In an aspect, the stake-controlled inflation may include a consensus calculation in the blockchain consensus component over a plurality of utility measurements, and a blockchain inflation distribution to a plurality of nodes in the utility network. Accordingly, such an aspect may ensure that majority stake in the proof-of-stake blockchain obtains majority inflation distribution, i.e., even when a minority stake subset of nodes reports incorrect utility measurements, where the method solution is to calculate a consensus uncertainty that penalizes low-consensus utility measurements. In sum, the system may include a statistical consensus calculation component (for example, within a proof-of-stake blockchain and peer-to-peer network), wherein an uncertainty measure penalizes low-consensus peer measurements. Also, the system may a stake-weighted consensus calculated on subjective individualized peer measurements that can involve complex utility. Thus, the system may include a stake-weighted mean consensus and analysis of the uncertainty of the consensus.

In another aspect, the system incentivizes the servers to prioritize service requests from clients in proportion to client stake or bonds as verified on the blockchain, so that clients with a higher proportion of stake or bonds obtain commensurately higher priority in the server priority queue. Thus, spending limited server resources may be prioritized on servicing requests from clients with a higher propensity to set weights on a server and purchase blockchain tokens directly or indirectly from servers thereby compensating them, as evidenced by blockchain-verified stake accumulated by a client. Limited server resources may also be prioritized for clients that manage to measure utility more accurately and thereby obtain comparatively larger rewards per bond unit held. Accordingly, in such an embodiment, server priority queues can probabilistically choose the next request to service according to a probability calculated as a function of blockchain-verified stake or bonds and estimated request service cost across all inbound requests. Further, utility markets typically require direct exchange of tokens or currency for utility, whereas this present aspect may require client stake or bonds in a proof-of-stake blockchain instead, wherein service priority is received commensurate with the relative stake or bonds. Servers may then receive a blockchain inflation distribution in accordance with the consensus on the relative utility provided, as measured by clients and stakeholders in the utility network and post-processed with the blockchain consensus algorithm. As part of operation, in an embodiment, clients may be required to purchase tokens from rewarded servers so that the clients can maintain a certain stake proportion in an inflating token circulation. In an embodiment, this operation is conducted external to the blockchain, which permits absolute pricing to be determined based on time-sensitive resource costs, while internally the blockchain can impose consensus on the relative pricing according to utility measurements. Thus, for example, bypassing the need for direct exchange of tokens for utility, the present invention obviates the need for absolute pricing oracles in its blockchain to determine exact resource costs, but may still impose a useful relative pricing structure through consensus.

In such a decentralized permissionless blockchain, the blockchain itself may be used to verify stake or the propensity to compensate for service. Further, the client stake may be verified directly on the blockchain, and the onerous demand of absolute price estimation may be shifted from the client to external markets by avoiding direct sale for priority access.

In another aspect, the system includes stake activation in a proof-of-stake blockchain; and a peer-to-peer network may require proof-of-work verified on the blockchain for a peer to register and then participate in validation and serving in a utility network (i.e., with a limited number of registration slots). Accordingly, in such an embodiment, the system may be configured to increase per capita work capacity in utility networks, where the method solution uses proof-of-work for potential peers to compete for limited registration slots, thus constraining blockchain storage and operating cost while maximizing overall potential utility across registered peers, where work ability is a proxy for the ability to deliver utility. Proof-of-work may determine and qualify peer-to-peer network composition in a proof-of-stake utility network. Typically, blockchain systems have mutually exclusive use of either proof-of-work or proof-of-stake, and in instances of hybrid proof-of-work/proof-of-stake the system usually restricts the scope of influence to the blockchain itself and not to peer-to-peer network composition, as is present in this embodiment. For example, the present aspect may utilize proof-of-work to alter peer-to-peer network composition by inserting and (possibly) replacing peers and activating peer-serving and peer-validating capabilities in a utility network.

The system for a proof-of-stake utility network may include a proof-of-stake blockchain network 302 and a peer-to-peer utility network 304, each comprising a plurality of nodes with communication between nodes inside and across both networks, such that utility network nodes 308 can also communicate with blockchain network nodes 306 in some instances, and vice versa.

In an embodiment, the blockchain network 302 may be a distributed system comprising a plurality of nodes that are communication entities on the network 302, where each node has a set of possible functions relating to transactions, the blockchain ledger, and the blockchain state. The blockchain nodes 306 may submit transactions to other nodes, receive submitted transactions from nodes, broadcast transaction proposals to other nodes, validate and verify received transactions, endorse and commit transactions to the blockchain, execute chaincode (i.e., smart contracts) on the blockchain, and maintain a copy of the blockchain ledger and state.

For the purposes of this disclosure, chaincode may refer to a blockchain program such as smart contracts, that is executed on certain blockchain nodes 306 during certain transactions, events, or triggers, and thereby typically change the blockchain ledger and state. Moreover, the nodes, as described herein, may be or may embody servers 107-113 and/or components thereof, client devices 102-106 and/or components thereof, device 200 and/or components thereof, or any other suitable device. Therefore, nodal communication, internal processing, storage of data, or other software aspects may be executed via any of the computerized components or hardware aspects described above.

In various embodiments, multiple utility nodes 308 may share access to the same blockchain node 306, instead of requiring a dedicated one-to-one connection between a utility node 308 and blockchain node 306.

In an embodiment, the blockchain ledger may be an append-only sequential transaction log of hash-linked data blocks, where each block includes a body with a limited set of one or more transactions or state transitions, and a header including a cryptographic hash of the set of transactions in the body, and a cryptographic hash of the header of the previous block. Consequently, the ledger may be an immutable record of transactions since the hash-linkage is tamper-resistant, and the most recent header hash may summarize and confirm the entire transaction history, which nodes may use to verify the consistency of their local blockchain ledger copy.

The blockchain state may be a database with the latest record of blockchain values after all committed transactions have been applied, and may include, but are not limited to, values such as transacting wallets, wallet balances, wallet stake, stake status (e.g., active or non-active), total token inflation, and current block reward. Further values pertaining to the utility network 304 may be included, such as registered nodes, network-wide utility measures typically recorded individually from one specific peer to another specific peer, incentive distributed to utility servers, and rewards received by stakeholders and clients.

The peer-to-peer utility network 304 may be a distributed system comprising a plurality of peer nodes 308 that are communication entities on the network, where each node 308 has a cold blockchain wallet 310 and a hot blockchain wallet 312, and a set of possible functions relating to requesting utility, prioritizing requests, serving utility, measuring and validating utility, and another set of possible functions relating to interacting with the blockchain network 302 to report utility measures, obtain and verify stake, transfer blockchain tokens, obtain utility network 304 configuration, register on the utility network 304 and activate stake.

The utility network 304 may require registration of candidate peer nodes on the blockchain node register 326, in order for new nodes to become active in the network. Accordingly, in an embodiment, the objective of the registration requirement may be to constrain the size of the blockchain ledger and state, where the largest data can be contained in the bond storage and weight storage 332, which can be N×N in size where N is the maximum number of peers supported in the utility network 304. In one embodiment, the size of the network can be fixed to a set size, e.g. N=4096, and can be increased or decreased over time. However, the network(s) may be any suitable size, either fixed and/or variable.

In various embodiments, the blockchain node register 326 may periodically decide to deregister existing nodes 308 on the utility network 304, based on a set of criteria, e.g., the relative level of utility provided as reflected in the weight storage 332 and consensus calculator such that the lowest utility nodes 308 are more likely to be deregistered. Deregistration of nodes in the network may open up unallocated slots in the utility network 304, that can subsequently be filled through registration of new candidate nodes.

Prospective or candidate peer nodes 304 that are yet unregistered on the blockchain, can initiate a registration procedure via communication with a blockchain node 306. In an embodiment, a candidate peer node 304 first generates a blockchain wallet private-public keypair designated as a cold wallet 310, then generates another blockchain wallet private-public keypair designated as hot wallet 312 linked to the cold wallet 310. Thereafter, in various embodiments, the candidate can sign, with the hot private key and/or cold private key, a registration request including the cold and hot public keys. Thereafter, the candidate may transmit the signed message, via the message signer 314, to a blockchain node 306, where the registration listener 320 in the blockchain node 306 may verify the authenticity of the message using the public keys in the message.

Upon establishing the authenticity, the blockchain node 306 may retrieve a challenge value from the local challenge storage 322 and may form and/or transmit a challenge message to the candidate peer. In such an embodiment, the candidate inputs the challenge into its challenge solver 318 that, for example, involves computational work to be performed until a solution is found that can be verified.

In various embodiments, a proof-of-work challenge can be used, which can be a generated with a secret seed (i.e., a backup for private key(s)) known only to blockchain nodes 306, where a salt value or another value may be added to the secret seed such that a known condition or result, like a zero sum, is met when the addition is passed through a one-way function like a hash function. The challenge may have the property that a solution is easily verifiable by requiring minimal computation, whereas finding a solution is difficult and may requires a great deal of computational effort. Although a proof-of-work challenge may be utilized, the system may employ any suitable type of challenge.

In various embodiments, the challenge difficulty can be deterministically controlled, e.g., by setting the seed length to a certain length. In such an embodiment, difficulty can then be controlled by blockchain nodes 306 to ensure, for example, that registrations probabilistically take place at an approximate fixed period. Blockchain nodes 306 may be configured to monitor the number of registrations in a particular period (e.g., the latest period), and if it exceeds a threshold, then the difficulty can be increased accordingly, and a new challenge may be generated and stored in the challenge storage 322.

Upon computing a solution, the candidate may transmit the solution to the blockchain node 306, which may verify the solution in its solution verifier 324 and may proceed to register the peer in the blockchain by recording in the ledger and state, the peer internet protocol address, cold wallet public key, hot wallet public key, and/or hot wallet token balance as designated stake.

A peer node on the utility network 304 may be registered by having a uniquely associated wallet on the blockchain and can have a specific amount of stake on that blockchain wallet with an active or inactive stake status depending on conditionalities of the peer node's functioning in the utility network 304.

In an embodiment, a peer node can be a stakeholder when it has active stake registered on the blockchain, and then it may submit transactions to the blockchain for reporting utility measures 330 of specific peers in the network, such that its non-zero active stake verified on the blockchain can influence the next block reward distributions.

Peers in the utility network 304 may communicate directly with one another via networking interfaces addressable according to peer registration data recorded in the blockchain state or a commonly accessible storage medium, which may include, but is not limited to, a peer internet protocol address and port, registered wallet address and public key, and request types supported.

As a non-limiting example, peer nodes as clients can request utility from other peers as servers in the utility network 304 and can evaluate and measure the utility of fulfilled requests, typically based on a local objective and/or target information.

In various embodiments, a utility request from a client 602 can contain a text and a request type specifying that a continuation of the text should be generated by the responding server 604. In an embodiment, the server 604 can use a local machine learning model such as a large language model, input the received text, and then output the continuation probabilities of the text in the form of a set of text phrase and probability pairs. In such an embodiment, the server 604 can respond to the client 602 with the subset of top probability text phrases that continue the input text. As a non-limiting example, if the input text is “You can't judge a book by its” then the server 604 can respond with possible continuations of “cover” (70%), “contents” (20%), and “title” (10%). In such a non-limiting example, the client 602 may then evaluate the response utility against a reference text that did have at least one continuation present, e.g. “You can't judge a book by its cover” and score the utility at an equivalent of 70% (“cover”) accuracy.

In an embodiment, clients 602 may submit the same request to a plurality of servers 604 and comparatively evaluate their responses via a local objective or target like a reference text. The comparative evaluation may allow the client 602 to assign a comparative weight to each server 604, such that all weights sum to one. As a non-limiting example, if ten servers respond with the same continuation probabilities, then each will receive a weight of 0.1, such that the weights normalize to a total of 1. However, in such a non-limiting example, if only two servers respond, one with an accuracy of 10%, and another with an accuracy of 90%, then the first will receive a weight of 0.1 and the second a weight of 0.9.

Clients 602 may submit a plurality of requests over time to the network, and may average their normalized weight evaluations over all requests. As a non-limiting example, a client i registered on the blockchain with non-zero stake Sᵢ>0 can then successfully submit to the blockchain their normalized weight averages Wᵢⱼ for peers j in the network, such that Σⱼ Wᵢⱼ=1.

In an embodiment, blockchain nodes 306 may periodically, e.g., every 100 blocks, execute specific chaincode with consensus algorithms to distribute new inflation via block rewards, according to the normalized weight averages Wᵢⱼ received from a plurality of peers in the network and the active stake of each peer. The blockchain nodes 206 may distribute new inflation at any suitable interval and/or may be triggered by any suitable event.

The bond calculator 342 in a blockchain node 306 may calculate a bond Bᵢⱼ=S′ᵢWᵢⱼ/Σₖ S′ₖWₖⱼ from each peer i to peer j, where the bonds in a peer j sum to 100% ownership and entitles each bond owner i to that share of the incentive distribution to j as a server, normally termed a reward distribution based on bond ownership. The normalized stake S′ᵢ may be used here, where Σᵢ S′ᵢ=1. In another embodiment, peer j can also have a certain self-ownership Bⱼⱼ>0, where this would normally be 50% self-ownership in one embodiment. In one embodiment, the blockchain nodes 306 can record and use a moving average of bond values over a window of blocks, instead of just the latest bonds. In the case of an exponential moving average (EMA) with coefficient α, the EMA bonds can be calculated as B̅ᵢⱼ^{(t+1)}=αBᵢⱼ+(1−α) B̅ᵢⱼ^{(t)}.

Rewards may incentivize peers to accurately measure utility even if peers do not actively require utility, since higher accuracy allow peers to place larger weight on servers with higher utility and consequently obtain larger rewards.

In an embodiment, the rank calculator 336 in a blockchain node 306 calculates and stores a rank for each registered peer in the utility network 304, and can be a function over stake storage 344 and weight storage 334. In various embodiments, a server rank Rⱼ=Σᵢ Sᵢ Wᵢⱼ can be calculated as the sum over all peers i, of the product of the active stake Sᵢ of the peer and the weight Wᵢⱼ assigned by the peer i to the particular server j. Rank may be normalized to sum to 1, i.e. Eⱼ Rⱼ=1. However, rank may be normalized to any suitable value or via any suitable methods.

The trust calculator 340 in a blockchain node 306 may calculate and store a trust value, which can be comprised of various trust factors, calculated as functions over stake storage 344, bond storage, rank storage, and weight storage 334. In various embodiments, a trust factor for relative weight consensus can be calculated, where trust for j can be defined in one embodiment as Tⱼ=(1−2dⱼ)^{p} with a trust power p typically larger than 1, and a bond-weighted standard variance dⱼ²=σ_{B}²(W′ᵢⱼ)=Σᵢ Bᵢⱼ (W′ᵢⱼ−μ_{B}(W′ᵢⱼ))² of j-normalized weights W′ᵢⱼ=Wᵢⱼ/Σᵢ Wᵢⱼ pointing at j, with bond-weighted average μ_{B}(W′ᵢⱼ)=Σᵢ BᵢⱼW′ᵢⱼ. However, trust factors may be calculated by any suitable means or by utilizing any appropriate metrics or values.

In another embodiment, a trust factor can be calculated in terms of a consensus Cⱼ as a bond-weighted average Cⱼ=μ_{B}(Wᵢⱼ)=Σᵢ BᵢⱼWᵢⱼ, specifically as Tⱼ=1−min(1, dⱼ/Cⱼ/s) with a bond-weighted standard variance dⱼ²=σ_{B}²(Wᵢⱼ)=Σᵢ Bᵢⱼ (Wᵢⱼ−μ_{B}(Wᵢⱼ))² and a maximum number of standard deviations s>1 to scale down with, typically s=3 to 5. Consequently, as a non-limiting example, a small deviation in terms of the consensus represents a small disagreement between bond holders on the weight of a peer, resulting in a relatively large trust. Otherwise, in such a non-limiting example, a large deviation results in a relatively low trust, where a deviation of s results in zero trust.

As depicted above, the trust calculator 340 may be configured to factor in a first trust component Tⱼ⁽¹⁾, wherein the first trust component is based on bond-weighted consensus and uncertainty of consensus. Further, the trust calculator 340 may be configured to factor in an additional trust component Tⱼ⁽²⁾ as a function over stake storage 344 and weight storage 334 on the blockchain, such that the final trust Tⱼ is calculated from all trust components, e.g. Tⱼ=Tⱼ⁽¹⁾Tⱼ⁽²⁾. In one embodiment, the additional trust component Tⱼ⁽²⁾=Σᵢ S′ᵢ (Wᵢⱼ>0) sums the stake of all peers i with a non-zero weight pointing to j.

In an embodiment, full trust may activate when a majority stake trusts that j is producing non-zero utility, e.g., with an activation function Tⱼ^{(2)′}=(1+exp (−ρ(Tⱼ⁽²⁾−κ)))⁻¹ with typical temperature ρ=10 to 50 and shift κ=0.5. The objective of such an additional trust component may be to ensure that the majority stake can remove trust for peers that produce no apparent utility, such that these peers effectively do not receive any direct incentive as a server. This trust component may address adversarial weight setting behavior where peers set incorrect weights to themselves to get incentive, even when they do not actually produce any utility.

The incentive calculator 338 may include a function over the rank calculator 336 and trust calculator 340, and may be configured to combine the rank and trust to calculate the incentive distribution Iⱼ to a peer j as Iⱼ=RⱼTⱼ, including a normalization such that Σⱼ Iⱼ=1.

The incentive distributor 346 may calculate and update on the blockchain the stake of each blockchain-registered peer in the utility network 304 according to the calculated incentive and bonds, where a peer i receives rewards Dᵢ=ΔS Σⱼ Iⱼ Bᵢⱼ from its self-ownership Bᵢᵢ and other-ownership Bᵢⱼ, with a fixed block reward ΔS distributed as total incentive. The incentive distributor 346 may then update each stake as Sᵢ^{(t+1)}=Sᵢ^{(t)}+Dᵢ.

In an embodiment, the blockchain reward distribution incentivizes servers to deliver utility and for peers to accurately measure utility, since the incentive distributor 346 may increase the blockchain stake amount in the stake storage 344 for peers according to their relative ability to provide and measure utility. However, as a non-limiting example, markets for this blockchain token, in which said markets facilitate the exchange of the token for another form of currency now only experience sell pressure, since utility servers require various computational, storage, networking and other resources with an external cost to provide utility and, consequently, need to exchange the blockchain token for another currency.

The following system and method for priority queuing may provide a means to introduce buy pressure in these markets, by requiring requesting peers to purchase tokens to improve their service priority by increasing their token stake on the blockchain.

Peer nodes may receive a plurality of requests from a subset of nodes on the utility network 304 in a given time period, where the total response time for all requests may typically exceed the receiving time period, such that some requests would have to be delayed or ignored in order to consistently process incoming requests over time. Each request may involve computation, storage, and networking time delays to produce complex informational utility, and with peer nodes typically comprising limited compute, storage, and networking resources then there will be a limit to their request handling capacity.

In various embodiments, each peer node j as server can maintain a priority queue 614 including a response cost estimator 616 and a deterministic or probabilistic sampling device over a set of requests identified by the sending peer i, its blockchain stake Sᵢ, bonds Bᵢⱼ, the request type and size. In various embodiments, the probabilistic sampling device in the priority queue 614 can include a probability storage for each request, where a probability value for responding to a query from i is calculated as a function of blockchain stake Sᵢ, bonds Bᵢⱼ, and the request types and sizes of all requests from i. The priority queue 614 may also maintain a response statistic storage with proportions Cᵢ of response cost expended on each bond holder i, which can be used in conjunction with the cost estimator 616 and bond proportions Bᵢⱼ to inform the request selector 620. In particular, for example, over time, the response cost proportion Cᵢ, may approximate the bond proportion Bᵢⱼ, i.e. Cᵢ≈Bᵢⱼ.

In an embodiment, the request selector 620 at j can function over the differences Bᵢⱼ−Cᵢ and the cost estimates E(rᵢ), and in a deterministic selection may choose the i with the maximum difference Bᵢⱼ−Cᵢ, i.e., argᵢ max Bᵢⱼ−Cᵢ, with the objective of responding to a request of a node that is as yet least served with respect to its bond. In an alternate embodiment, the request selector 620 can choose to minimize the total absolute difference via argᵢ min σₖ|Bₖⱼ−(Cₖ−E(rₖ)·1ₖ₌ᵢ)/Σₘ(Cₘ−E(rₘ)·1ₘ₌ᵢ)|, wherein 1ᵢ is the indicator function that is 1 only when k=i, and 0 otherwise. The purpose in this alternate embodiment may be to fulfil the request that will most closely match the bonds with the overall response cost, ensuring that servers spend their limited computational resources on clients that duly reward the server via weight setting.

In another embodiment, the sampling probability can be calculated as Pₖ=S′ₚ₍ₖ₎/E(rₖ), such that Σₖ Pₖ=1, with the requesting peer p(k) having blockchain stake Sₚ₍ₖ₎ provided by the stake storage 344 in a blockchain node 306 and the response cost estimator 616 E(rₖ) calculating the relative cost of computation, storage, and networking involved in producing utility. In one embodiment, for generative text requests involving a large language model, the relative cost can scale with the number of input and output tokens, so a request with a thousand input tokens and thousand output tokens would be ten times higher in cost than a request with only one hundred input tokens and one hundred output tokens.

The probabilistic sampling device may also include a probabilistic sampler that chooses a specific received request, such that the probability of choosing the request from p(k) is approximately equal to the calculated probability Pₖ. In a further embodiment, multiple requests can be received from the same peer p(k), in which case the probabilities of these requests will be handled separately. The peer stake may be a direct factor in the probability, hence peers with more stake may have a higher probability of getting their requests serviced.

In an embodiment, the peer thus chooses the next request from the probabilistic sampling queue and proceeds to respond to the request, then removes it from the queue, before continuing to sample the next request from the queue. However, alternatively, peers with multiple processors that support multiprocessing or multithreading may simultaneously choose multiple requests to process to fully occupy the available compute resources. The peer may include a data storage 628 and/or a data sampler 630, wherein the data sampler 630 is in informative communication with the request submitter 606. In an embodiment, the data storage 628 may contain data capable of being formed into a request by the data sampler 630.

In various embodiments, responding to a request for informational utility can involve computation according to a local machine learning model, such as transformer-based large language models or generative image models that can receive a structured input and output a useful response. In the text modality, a large language model can receive as input a sequence of text symbols or phrases, and can output a learnt probability distribution of possible continuations of the input sequence. This generally has high utility in the case of large well-trained machine learning models that can generate computer programs given a general text description of a desired program capability, or produce a news article given a brief list of statements, or summarize a lengthy scientific paper in layman's terms, for example.

As a non-limiting example, a peer on the utility network 304 can query servers on the network to measure their utility and then set weights via a blockchain node 306, where weights correspond to the relative utility of each queried server. Firstly, a peer may request the list of registered nodes from a blockchain node 306, which may retrieve the registration details from the blockchain state and responds with it to the peer. The network querier 632 may facilitate communication between a client 602 or peer and a blockchain node 306. In such an embodiment, the network querier 632 may communicate with the node register 348, wherein the node register 348 includes a list of registered nodes. The peer may choose one or more registered nodes to query, according to some criteria such as a fixed subset size of nodes to evaluate with the same query, and may consult the request types supported by the nodes, including only those nodes that support the intended request type. Thereafter, the requesting peer may formulate a request message, in various embodiments this can be based on local storage with representative data to evaluate against, for example, especially if this peer is only incentivized to share in the rewards of servers by accurately evaluating their utility through validation requests. Representative data can include, but is not limited to, text, images, audio, and/or video. As non-limiting example, representative data may include text from digitized books, online forums, websites; or images collected from various websites and digitized image collections. The peer samples from the representative data may be a small sample to query with, e.g., a text paragraph or sentence akin to “You can't judge a book by its cover.” However, the request may withhold part of the sample, rather expecting that the server should complete the missing parts of the sample. In this case, the request may become an incomplete text “You can't judge a book by its”, accompanied by a request type specifying e.g., text completion, indicating that the provided text should be completed or continued with the next text component.

Then the client peer sends the request to the selected server or server subset (also referred to as the one or more selected servers), via a request submitter 606, where the receiving server(s) has a request listener 612 that sends the request to the response cost estimator 616 and stake verifier 618. The stake verifier 618 may connect with a blockchain node 306 and may request the blockchain-verified stake of the client. The server priority queue 614 may then compute the request queue probability from the client stake divided by the estimated response cost and places the request in the queue. In various embodiments, a probabilistic queue sampler at some point samples this request and proceeds to compute a response for the client. Then, the server response processor 622 may input the query and may select, in various embodiments, a machine learning model appropriate for the request type, e.g., a transformer-based large language model in the case of text completion or continuation. In such a non-limiting example, the request text “You can't judge a book by its” becomes the input to the language model, and the output are a set of continuation texts with accompanying probabilities, e.g., “cover” (70%), “contents” (20%), and “title” (10%) in this case. The server can respond with all the possible phrases and probabilities, or truncate the selection to the top probabilities only, e.g., the top 10 probabilities. In an embodiment, the server may include a model selector 624 configured to select an appropriate model as described herein. Accordingly, the local model 626 may be configured to provide a solution to the query based on the model selected by the model selector 624. The models described herein may be executed and/or used in connection with any suitable machine learning, artificial intelligence, and/or neural network methods. For example, the machine learning models may be one or more classifier and/or neural network. However, any types of models may be utilized, including regression models, reinforcement learning models, vector machines, clustering models, decision trees, random forest models, Bayesian models, Natural Language Processing, and/or Gaussian mixture models. In addition to machine learning models, any suitable statistical models and/or rule-based models may be used.

The client 602 may receive the response from the server 604, and may match the response to the outgoing request to then contain the original sample “You can't judge a book by its cover”, the request text “You can't judge a book by its” and the responses “cover” (70%), “contents” (20%), and “title” (10%) in memory. Then the client 602 may perform the utility measure 610, e.g. a function of the correct probability for “cover” (70%). In an embodiment, a comparative evaluation can be performed across all queried servers, e.g., if another server responds with a single probability “cover” (100%), it may get 100/70 greater weight than the server with the “cover” (70%) response.

In an embodiment, the client 602 updates its weight storage 608 with the new evaluation weight entries for latest queried servers, where the update can be a moving average over a window of weight update events. Periodically, the client 602 may submit its hot wallet signed weights in weight storage 608 to a blockchain node 306, which may record the weights in the blockchain ledger and state, and may include it in the following incentive distribution events.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A computer-implemented method for proof-of-stake validated serving of stake-prioritized utility comprising one or more processors, one or more computer-readable memories, and one or more computer-readable storage devices, and program instructions stored on at least one of the one or more computer-readable storage devices for execution by at least one of the one or more processors via at least one of the one or more computer-readable memories, comprising the steps of:
requesting, via a requesting peer, a list of registered nodes from a blockchain node;
formulating, via the requesting peer, a request message;
transmitting, from the requesting peer to one or more selected servers, the request message;
inputting, via a server response processor for each of the one or more selected servers, the request message;
selecting, via the server response processor for each of the one or more selected servers, a machine learning model appropriate for a request type,
wherein the request message comprises the request type;
receiving, via the requesting peer, a response from each of the one or more selected servers;
matching, via the requesting peer, the response to the request message;
performing, via the requesting peer, a utility measure; and
updating a weight storage with a weight entry for each of the one or more selected servers.

2. The computer-implemented method of claim 1, further comprising:
Selecting the one or more selected servers from the list of registered nodes according to one or more criteria, the one or more criteria comprising at least the request type.

3. The computer-implemented method of claim 1, wherein formulating, via the requesting peer, the request message is based on reference data.

4. The computer-implemented method of claim 3, wherein the request message withholds a portion of the reference data from the one or more selected servers.

5. The computer-implemented method of claim 1, wherein each of the one or more selected servers comprises a request listener, a response cost estimator, and a stake verifier, wherein the request listener is configured to receive the request message, wherein the response cost estimator is configured to generate a cost estimate based on the request message, and wherein the stake verifier is configured to connect with the blockchain node and request a blockchain-verified stake of the requesting peer.

6. The computer-implemented method of claim 1, wherein the weight entry for each of the one or more selected servers is a moving average over a window of weight update events.

7. The computer-implemented method of claim 1, furthering comprising:
submitting one or more hot wallet signed weights to the blockchain node; and
recording the one or more hot wallet signed weights in a blockchain ledger and a state.

8. The computer-implemented method of claim 1, further comprising:
generating, via a candidate peer node comprising a cold wallet and a hot wallet, a cold blockchain wallet private-public keypair designated as the cold wallet;
generating, via the candidate peer node, a hot blockchain wallet private-public keypair designated as the hot wallet,
wherein the hot wallet is linked to the cold wallet,
wherein the cold blockchain wallet private-public keypair comprises a cold public key and a cold private key, and
wherein the hot blockchain wallet private-public keypair comprises a hot public key and a hot private key;
signing, via the candidate peer node, a registration request with at least one of the cold private key and the hot private key,
wherein the registration request comprises at least one of the cold public key and the hot public key;
transmitting the signed registration request to the blockchain node;
verifying, via a registration listener and the at least one of the cold public key and the hot public key, an authentic status or inauthentic status of the signed registration request;
retrieving, if the signed registration request is of the authentic status, via the blockchain node, from a challenge storage a challenge message;
transmitting the challenge message to the candidate peer node; and
inputting the challenge message to a challenge solver,
wherein the challenge solver is configured to compute a solution corresponding to the challenge message.

9. The computer-implemented method of claim 8, wherein the challenge message is a proof-of-work challenge, the proof-of-work challenge comprising a generated secret seed known only to the blockchain node.

10. The computer-implemented method of claim 9, wherein the challenge message comprises a challenge difficulty, wherein the challenge difficulty is modifiable via the blockchain node.

11. The computer-implemented method of claim 1, updating the weight storage further comprising comparative evaluation adapted to allow the requesting peer to assign a comparative weight to each of the one or more servers,
wherein all comparative weights sum to one.

12. The computer-implemented method of claim 11, further comprising executing a consensus algorithm configured to distribute inflation via block rewards according to each of the comparative weights for each of the one or more servers.

13. The computer-implemented method of claim 1, furthering comprising calculating, via a bond calculator in the blockchain node, a bond for the requesting peer, wherein the bond correlates to a share of an incentive distribution of each of the one or more selected servers.

14. The computer-implemented method of claim 1, further comprising calculating and storing, via a rank calculator in the blockchain node, a server rank for each of the one or more selected servers, wherein the rank is a function of a stake storage and the weight storage, wherein the rank is calculated as the sum over registered peers of the product of an active stake of said registered peer and the weight assigned by said registered peer to a particular server of the one or more selected servers.

15. The computer-implemented method of claim 1, further comprising calculating and storing, via a trust calculator in the blockchain node, a trust value comprising one or more trust factors, the one or more trust factors functions of a stake storage, a bond storage, a rank storage, and the weight storage, and wherein a first trust component is based on a bond-weighted consensus and uncertainty of consensus.

16. The computer-implemented method of claim 15, wherein the trust calculator is configured to factor a second trust component as a function over the stake storage and the weight storage on the blockchain, wherein the final trust is calculated from at least the first trust component and the second trust component, wherein the second trust component sums the stake of the registered peers with a non-zero weight pointing to one of the one or more selected servers, and wherein a full trust is activated when a majority stake trusts that the one of the one or more selected servers is producing non-zero utility.

17. The computer-implemented method of claim 16, further comprising calculating an incentive distribution, via an incentive calculator, the incentive calculator configured to combine the rank and the trust to calculate the incentive distribution for each of the one or more selected servers.

18. The computer-implemented method of claim 17, further comprising calculating and updating, via an incentive distributor, the stake of each of the registered peers based on at least said calculated incentive distribution.

19. The computer-implemented method of claim 1, further comprising maintaining, for each of the one or more servers, a priority queue comprising a response cost estimator and a sampling device, wherein the sampling device comprises a probability storage for the request message, wherein a probability value for responding to the request message is calculated as a function of blockchain stake, bonds, and the request types.

20. A system for proof-of-stake validated serving of stake-prioritized utility comprising one or more processors, one or more computer-readable memories, and one or more computer-readable storage devices, and program instructions stored on at least one of the one or more computer-readable storage devices for execution by at least one of the one or more processors via at least one of the one or more computer-readable memories, the program instructions which, when executed by the one or more processor, cause the one or more processor to:
request, via a requesting peer, a list of registered nodes from a blockchain node;
formulate, via the requesting peer, a request message;
transmit, from the requesting peer to one or more selected servers, the request message;
input, via a server response processor for each of the one or more selected servers, the request message;
select, via the server response processor for each of the one or more selected servers, a machine learning model appropriate for a request type,
wherein the request message comprises the request type;
receive, via the requesting peer, a response from each of the one or more selected servers;
match, via the requesting peer, the response to the request message;
perform, via the requesting peer, a utility measure; and
update a weight storage with a weight entry for each of the one or more selected servers.
